(19) United States
(12) Patent Application Publication
(10) Pub. No.: US 2008/0298942 A1
(43) Pub. Date: Dec. 4, 2008

(54) TAB AND SLOT LIFTGATE PLATFORM

(76) Inventors: Dane Gregg, Uniontown, OH (US); Peter J. Savoy, Akron, OH (US)

Correspondence Address: Emerson, Thomson & Bennett, LLC, 777 W. Market Street, Akron, OH, 44303, US

(21) Appl. No.: 11/853,150

(22) Filed: Sep. 11, 2007

Related U.S. Application Data
(60) Provisional application No. 60/825,480, filed on Sep. 13, 2006.

(51) Int. Cl. B60P 1/44; B23P 19/04; B60P 1/00

(52) U.S. Cl. 414/545; 29/700; 296/50

(57) ABSTRACT

A liftgate platform assembly may include: (a) a platform support structure having a plurality of non-tube brace members each having a first and a second tab; and, (b) a platform including a plurality of slots. The tabs of the non-tube brace members are received within the slots in order to attach the platform to the platform support structure.

This application claims priority from U.S. provisional patent application Ser. No. 60/825,480 titled TAB AND SLOT LIFTGATE PLATFORM filed on Sep. 13, 2006, which is incorporated herein by reference.

### I. BACKGROUND OF THE INVENTION

A. Field of Invention

This invention pertains to the art of methods and apparatuses regarding liftgates and more specifically to methods and apparatuses regarding the attachment of a liftgate platform to the platform support structure.

B. Description of the Related Art

It is well known in the art to attach liftgates to vehicle trailers or other forms of vehicle cargo holds to assist with loading and unloading of the vehicles. In general, liftgates include a platform or deck and some motorized system, often including a hydraulic system, used to move the platform. To load cargo from a ground surface to the vehicle bed, the platform is positioned in a lowered position where it is generally parallel with the ground surface. The cargo can then be easily placed onto the platform. The platform is then lifted to a raised position generally parallel with the vehicle bed. The cargo can then be easily loaded into the vehicle. To unload cargo from the vehicle, the reverse steps are taken.

Various types and styles of liftgates are known in the art. Some non-limiting examples include conventional liftgates, flip-a-way or fold-up liftgates, rail type liftgates, and special purpose liftgates. Generally, each type of liftgate has multiple options including various platform sizes and various load capacities.

FIG. 1 shows a well known liftgate assembly 1, a rail type liftgate assembly, that includes a platform assembly 2 having a platform or deck 3 that is attached, typically welded, to a platform support structure 4. The platform 3 is typically formed of steel. The platform support structure 4 includes multiple brace members 5 that are assembled together to form a rigid support. The number, orientation, and spacing of brace members 5 will vary depending on the loads the platform assembly 2 is designed to support. As shown in FIG. 2, each brace member 5 is a metal tube, meaning that it has a continuous outer periphery 6 of material with a hollow mid-section 7. The tube shown has a rectangular periphery in cross section but tubes may have various periphery cross sectional shapes including circular and triangular. The use of tubes in forming the brace members 5 of a platform support structure is the standard practice and generally works well for its intended purpose. There are problems, however, with the use of brace members formed of tubes.

One problem with tubes is their relative lack of straightness. More specifically, tubes made in the conventional way are not straight enough for automated robotic welding. This then requires manual welding, which generally increases the time and expense required to make the welds. What is needed is a more precise method.

Another problem with tubes is the requirement for significant tooling fixtures to hold the tubes in place for welding. The tubes are rather bulky and there is no convenient way to hold them in place. As a result, relatively elaborate holding fixtures are required. What is needed is a way to greatly reduce the amount holding fixtures required.

Still another problem with tubes is the strength limitations. It is generally difficult to obtain tubing from the relatively higher strength materials due to the method of forming tubes which consists of first forming a “circular in cross section” component. What is needed is a way to form the parts without the limitations that come from tubes.

The present invention provides methods and apparatuses for improving the attachment of a liftgate platform to a platform support structure. This invention, thus, overcomes the foregoing difficulties and others while providing better and more advantageous overall results.

### II. SUMMARY OF THE INVENTION

According to one embodiment of this invention, a liftgate assembly may be assembled with the following steps: (a) providing a platform for use with a liftgate assembly; (b) forming at least first and second slots in the platform; (c) providing a first sheet of material having at least a first tab on one side of the sheet of material and at least a second tab on the other side of the sheet of material; (d) forming the first sheet of material into a brace member; (e) inserting the first tab into the first slot; and, (f) inserting the second tab into the second slot.

According to another embodiment of this invention, prior to the step of, inserting the second tab into the second slot, the method includes the step of: overcoming a brace member spring force by squeezing one side of the brace member toward an opposite side of the brace member.

According to another embodiment of this invention, a liftgate assembly includes: a mount assembly for use in mounting a liftgate assembly to an associated vehicle; a platform assembly including: (a) a platform support structure having a plurality of non-tube brace members, wherein each non-tube brace member has at least a first and a second tab; and, (b) a platform having a traffic surface for use in receiving traffic for loading and unloading cargo and a plurality of slots; and, a lift assembly for use in moving the platform assembly between a lowered position and a raised position. The tabs of the non-tube brace members are received within the slots in order to attach the platform to the platform support structure;

One advantage of this invention is that the weight of platform assemblies can be reduced.

Another advantage of this invention is that the platform support structure can be more accurately formed.

Another advantage of this invention is that the cost in manufacturing liftgate assemblies can be minimized due, in part, to the use of robotic welding.

Another advantage of this invention is that liftgate components can be made in a less expensive manner.

Still another advantage of this is that expensive weld fixtures can be eliminated.

Yet other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective view of a prior art liftgate assembly showing the platform support structure formed of tube members.

FIG. 2 is a close up view showing a portion of a tube used to make a platform support structure in a manner known in the prior art.

FIG. 3 is a perspective view of a vehicle equipped with a liftgate assembly including the use of a platform support structure made according to this invention.

FIG. 4 is a plan view of a platform made according to this invention.

FIG. 5 is a plan view of a platform support structure made according to this invention.

FIG. 6 is a plan view of a sheet used to form a brace member according to one embodiment of this invention.

FIG. 7 is a view similar to that shown in FIG. 6 but showing an alternate embodiment.

FIG. 8 is a perspective view showing one embodiment of a brace member formed in a U-shape.

FIG. 9 is an end view of a brace member illustrating a generally U-shape but with the sides formed at an angle.

FIG. 10 is an end view of another embodiment brace member.

FIG. 11 is an end view of yet another embodiment of a brace member.

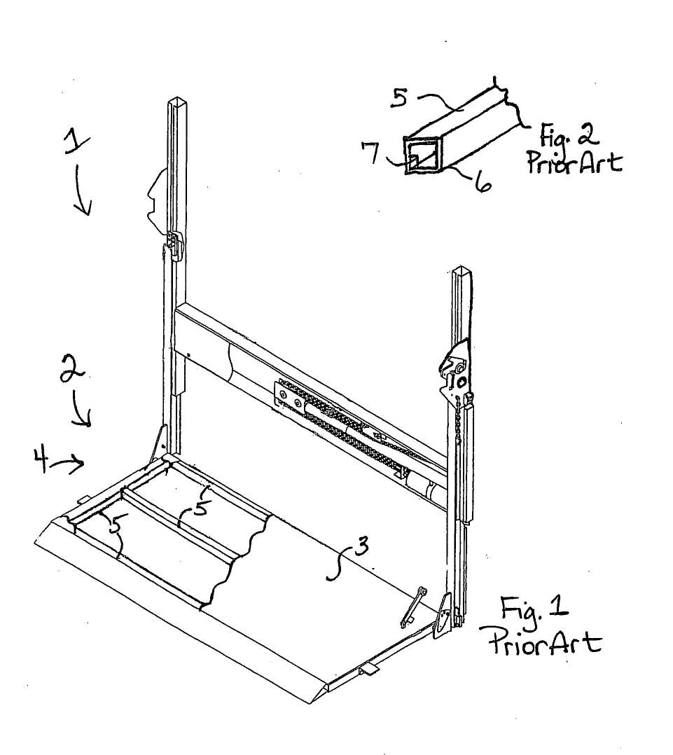

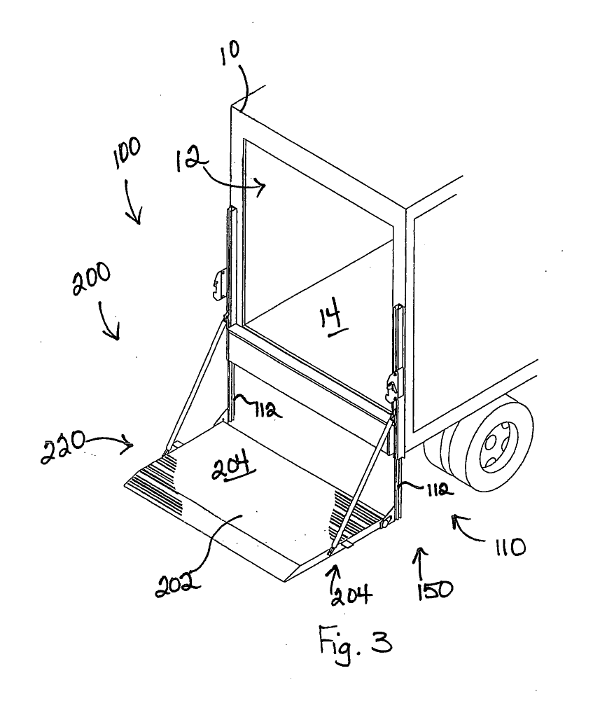

### IV. DETAILED DESCRIPTION OF THE INVENTION

Referring now to the drawings wherein the showings are for purposes of illustrating embodiments of the invention only and not for purposes of limiting the same, FIG. 3 shows a liftgate assembly 100 including a platform assembly 200 according to this invention. While the liftgate assembly 100 shown is the style known as rail type, it is to be noted that this invention may be used with any liftgate style, type and size, when applied with sound engineering judgment. The liftgate assembly 100 may be mounted to a vehicle 10 having a cargo hold 12 with a vehicle bed 14. The vehicle 10 may also have vehicle frame members (not shown) to which the liftgate assembly 100 may be attached to the vehicle 10 in any conventional manner. Any type and style of vehicle will work well with this invention when applied with sound engineering judgment.

With continuing reference to FIG. 3, the liftgate assembly 100 may include a mount assembly 110, the previously mentioned platform assembly 200, and a lift assembly 150. The mount assembly 110 is used to mount the liftgate assembly 100 to the vehicle 10 in any conventional manner and thus will not be described in detail. The lift assembly 150 is used to move the platform assembly 200 between a lowered position (shown in FIG. 3) and a raised position (not shown but well known in the art). The lift assembly 150 may include a control system (not shown) and a power system (not shown) used to move the platform 202. The basic operation of the control and power systems is well known and will not be described in detail.

With reference now to FIGS. 3-5, the platform assembly 200 includes the platform 202 which may be attached to a platform support structure 220. The platform support structure 220 is attached in any conventional manner to the liftgate assembly 100. For the embodiment shown, the platform support structure is attached to a pair of rails 112, 112 in a known manner. The platform or deck 202 may be a generally planar sheet or plate member having have a traffic surface 204 adapted to receive traffic for loading and unloading cargo. In one embodiment, the traffic surface may include a raised crossed-deck plate, otherwise known as a diamond deck plate. However, the platform 202 can have any form or shape chosen with sound engineering judgment. The platform support structure 220 includes multiple brace members 222 that are assembled to form a rigid support for the platform 202 in an inventive way.

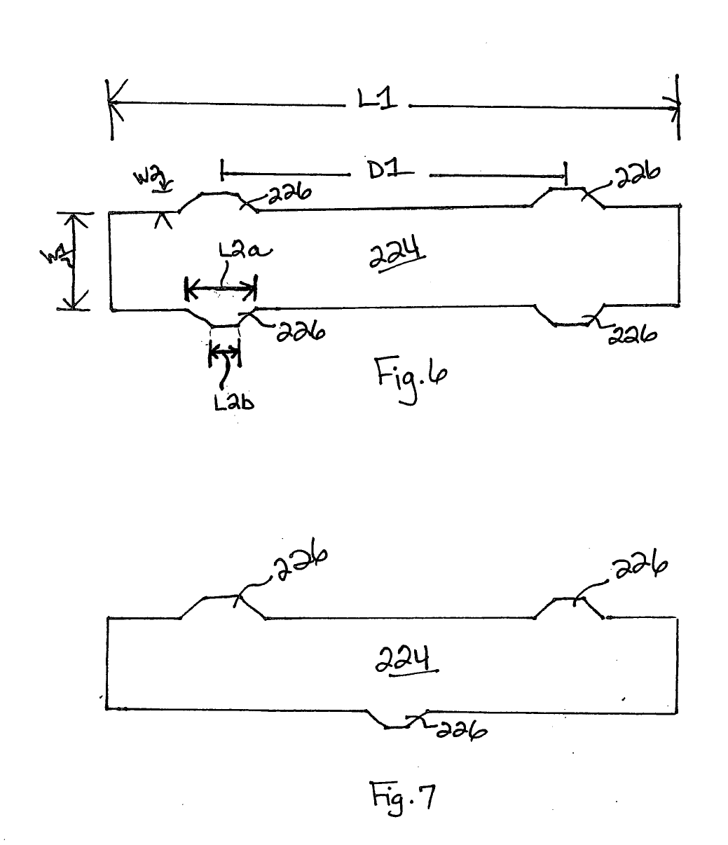

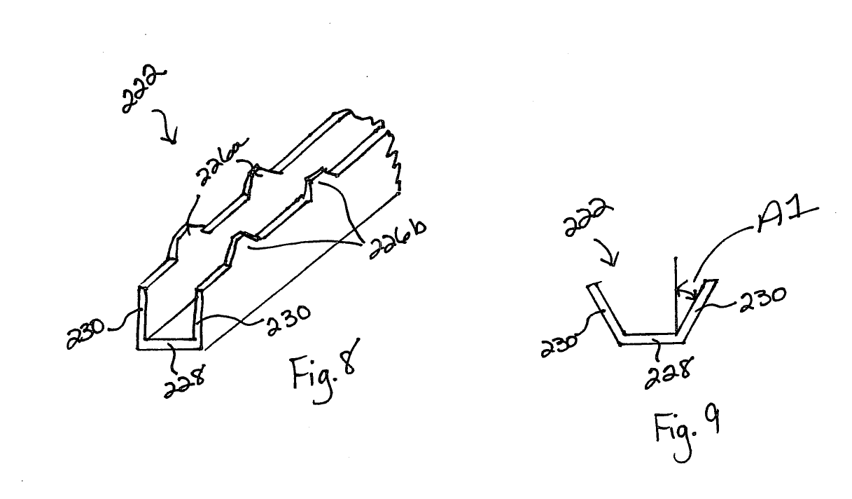

With reference now to FIGS. 3 and 5-8, the brace members 222 of this invention are not formed of tubes as is the common current practice. Rather, each brace member 222 may be formed from a sheet 224 of material having a length L1 and a width W1 chosen based on the particular load requirements for the specific liftgate assembly 100 being manufactured. Extending from the sides of the sheet 224 are tabs 226 which are used in a manner to be described below. By forming brace members 222 in this way the dimensional and alignment accuracy can be controlled in a manner superior to that possible using tubes. The tabs 226 can be formed in any conventional manner. In one embodiment, the tabs 226 extend along the same plane as the sheet 224. In another embodiment, at least one of the tabs 226 extends from the sheet 224 at an angle with respect to the sheet 224. In one embodiment, the tabs 226 have the same thickness as the sheet 224. In another embodiment, at least one of the tabs 226 has a thickness different than the thickness of the sheet 224. The particular shape of each tab 226 can be any chosen with sound engineering judgment. For the embodiment shown, each tab 226 has three sides but it should be understood that this is a non-limiting example only. In other embodiments a tab 226 may have two sides (forming a wedge shape), four or more sides, and/or one or more curvilinear outer surfaces. Each tab 226 may have a proximal length L2a and a distal length L2b as well as a width W2 each chosen with sound engineering judgment. In one embodiment, the tab width W2 is approximately equal to the thickness of the platform 202. The dimensions of one tab 226 may differ from another tab 226 while in another embodiment, all the tabs 226 may have the same dimensions. The tabs 226 may be spaced from one another a constant distance D1. In another embodiment, the distance between neighboring tabs 226 may vary. In one embodiment, shown in FIGS. 6 and 8, the tabs 226 extending from one side of the sheet 224 are aligned with the tabs 226 extending from the opposite side. In another embodiment, shown in FIG. 7, the tabs 226 extending from one side of the sheet 224 are offset longitudinally from the tabs 226 extending from the opposite side.

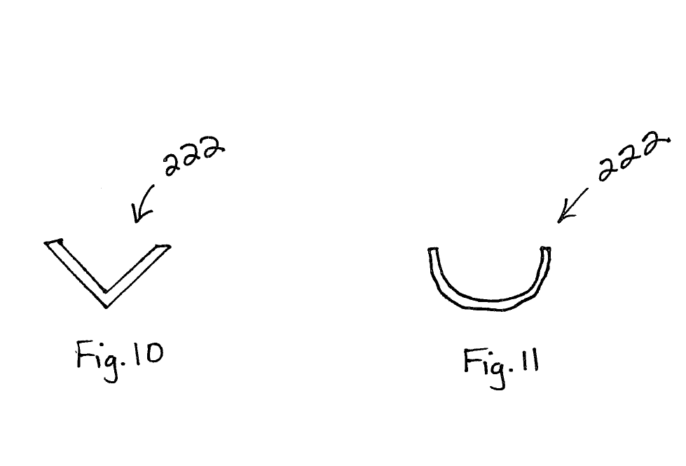

With reference now to FIGS. 6-11, each sheet 224 with tabs 226 may be formed, in any conventional manner, into one or more brace members 222. In one embodiment, the sheet 224 is cut from a plate using either a plasma or a laser cutting table. The sheet 224 may then be placed into a form press or bender system where it may formed into a brace member 222. In one embodiment, shown in FIG. 8, the sheet 224 is formed into a U-shaped cross section. It should be noted that the U-shaped cross section is a non-limiting example only. Any non-tube shape chosen with sound engineering judgment will work well with this invention. Other non-limiting examples of cross sectional shapes that will work well with this invention include a V-shape, shown in FIG. 10, and a semi-circular shape, shown in FIG. 11. In one embodiment, shown in FIG. 8, the brace member 222 has a bottom 228 and a pair of sides 230, 230 that are substantially perpendicular to the bottom 228. In another embodiment, shown in FIG. 9, at least one of the sides 230 is angled at a substantially non-perpendicular angle A1. This angle A1 creates a spring force that will be described further below.

With reference now to FIGS. 3-4 and 6, the platform 202 may have a plurality of slots 50 each of which adapted to receive one of the tabs 226. In one embodiment, the slots 50 fully penetrate the platform 202 creating holes through the platform 202. In another embodiment, the slots 50 only partially extend through the platform 202. In one embodiment, the slots are spaced a distance D2 that is substantially equal to the distance D1 between tabs 226. In another embodiment, the distance D2 between neighboring slots 50 is slightly different than the distance D1 between tabs 226 to increase the friction fit when the tabs 226 are inserted into the slots 50. A slot 50 may have a length L3 and/or width W3 slightly larger than the proximal length L2a and/or width W2 of the corresponding tab 226 to permit a relatively easy yet snug connection. In another embodiment, a slot 50 may have a length L3 and/or width W3 substantially larger than the proximal length L2a and/or width L2 of the corresponding tab 226 to permit a very easy insertion of the tab 226 into the slot 50. The slots 50 may be formed into the platform 202 in any conventional manner. In one embodiment they can be cut with a laser cutter. In another embodiment, the slots 50 may be “punched out” or “stamped out” in a manner well known.

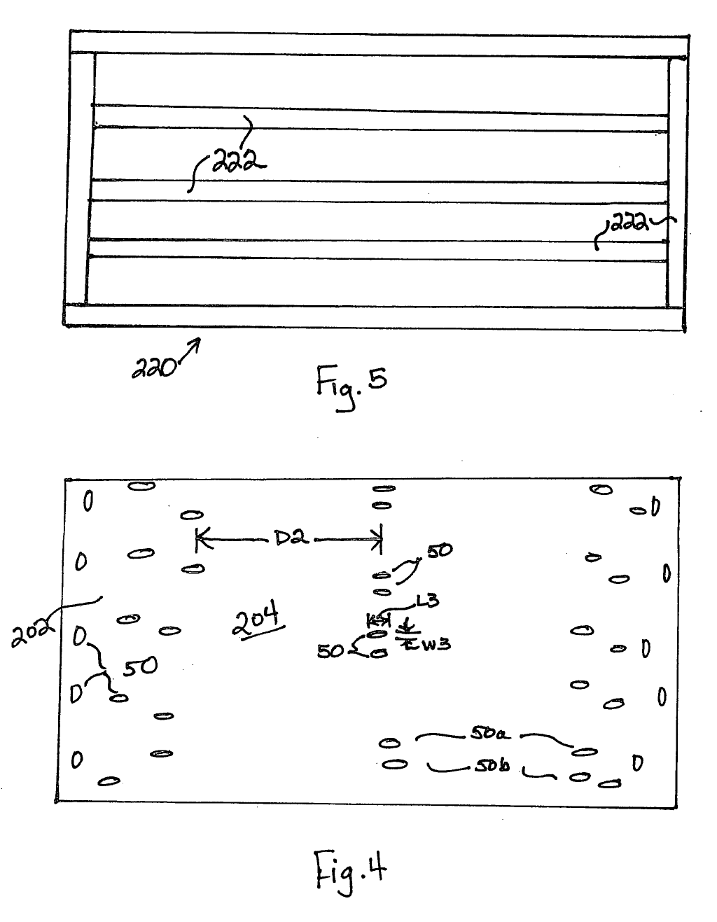

With reference now to FIGS. 3-9, the assembly of the platform assembly 200 will now be described. A brace member 222 is positioned so that the tabs 226 on at least one side of the brace member 222 are received within corresponding slots 50 in the platform 202. For example, tabs 226a (shown in FIG. 8) may be inserted within slots 50a (shown in FIG. 4). In one embodiment, the next step is to insert the tabs 226b on the other side of the brace member 226 within corresponding slots 50b in the platform 202. In another embodiment, when for example at least one of the sides 230 is angled at a substantially non-perpendicular angle A1 as shown in FIG. 9, prior to inserting the tabs 226b into slots 50b, the spring force is overcome. This may be accomplished, for example, by pushing or squeezing one side 230 toward the opposite side 230. Once the tabs 226b are inserted into the slots 50b, the spring force helps to hold the brace member 226 in position relative to the platform 202.

With continuing reference to FIGS. 3-9, after the tabs 226 are correctly positioned with the slots 50, a welding operation can begin. It should be noted that the use of brace members 222 formed according to this invention provides for much straighter positioning of the brace members 222 with respect to the platform 202. As a result, the welds can be made with a laser welder. In another embodiment, at least some of the welds are made manually. In both cases, it is much easier to make the welds because of the increased alignment accuracy provided by this invention. The precise length and number of welds may vary depending on the particular dimensions and materials. In one embodiment, a weld is made along the entire length of the brace member 222 on one side at the seam between the brace member 222 and the platform 202. It may be desirable to weld along the opposite side of the brace member 222 as well. If necessary, such as may be in the case where the slots 50 extend all the way through the platform 202, the assembly may be turned over and a weld may be made along the top surface of the platform 202—along the corresponding slots 50. The slots 50 receiving the tabs 226 may be sealed in any manner chosen with sound engineering judgment, such as by using a caulking material.

With reference now to all the FIGURES, a platform assembly 200 formed according to this invention has many advantages over platform assemblies formed with tubes. One advantage is in saved material because tubes have a continuous outer periphery of material and brace members 222 formed as described above have an open portion yet maintain the required structural rigidity. Another advantage is that the specific dimensions of the sheet 224 can be more accurately specified to the liftgate capacity rather than depending on the standard dimensions supplied by the tube mill. Still another advantage is that higher strength alloys can be used. Another advantage is that common robotic tooling for cutting, forming, and welding can be used across the entire product line thereby simplifying the manufacturing process.

Multiple embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof. For example, while the embodiments above relate to the attachment of a liftgate platform 202 to a platform support structure 220, this invention could also be used in the assembly of other liftgate assembly 100 components. Some non-limiting examples include lift arms and mount tubes.

Having thus described the invention, it is now claimed:

1. A method comprising the steps of:
providing a platform for use with a liftgate assembly;
forming at least first and second slots in the platform;
providing a first sheet of material having at least a first tab on one side of the sheet of material and at least a second tab on the other side of the sheet of material;
forming the first sheet of material into a brace member;
inserting the first tab into the first slot; and,
inserting the second tab into the second slot.

2. The method of claim 1 wherein the step of, forming at least first and second slots in the platform, comprises the step of:
forming the first and second slots to fully penetrate the platform to create holes through the platform.

3. The method of claim 1 wherein the step of, forming at least first and second slots in the platform, comprises the step of:
forming the first and second slots with a laser cutter.

4. The method of claim 1 wherein the step of, forming at least first and second slots in the platform, comprises the step of:
forming the first and second slots to have a length and width slightly larger than the corresponding proximal length and width of the first and second tabs to permit a snug connection therebetween.

5. The method of claim 1 wherein the step of, providing a first sheet of material having at least a first tab on one side of the sheet of material and at least a second tab on the other side of the sheet of material, comprises the step of:
providing the first tab at an angle that is substantially greater than zero degrees with respect to the sheet of material.

6. The method of claim 1 wherein the step of, providing a first sheet of material having at least a first tab on one side of the sheet of material and at least a second tab on the other side of the sheet of material, comprises the step of:
providing the first tab to have at least two sides.

7. The method of claim 1 wherein the step of, providing a first sheet of material having at least a first tab on one side of the sheet of material and at least a second tab on the other side of the sheet of material, comprises the step of:
providing the first tab in alignment longitudinally with the second tab.

8. The method of claim 1 wherein the step of, providing a first sheet of material having at least a first tab on one side of the sheet of material and at least a second tab on the other side of the sheet of material, comprises the step of:
providing the first tab to be offset longitudinally with respect to the second tab.

9. The method of claim 1 wherein the step of, forming the first sheet of material into a brace member, comprises the step of:
forming the first sheet of material into a U-shaped brace member.

10. The method of claim 1 wherein the step of, forming the first sheet of material into a brace member, comprises the step of:
forming the first sheet of material into a V-shaped brace member.

11. The method of claim 1 wherein prior to the step of, inserting the second tab into the second slot, the method comprises the step of:
overcoming a brace member spring force.

12. The method of claim 11 wherein the step of, overcoming a brace member spring force, comprises the step of:
squeezing one side of the brace member toward an opposite side of the brace member.

13. The method of claim 1 further comprising the step of:
welding the brace member to the platform.

14. The method of claim 1 further comprising the step of:
sealing the slots.

15. The method of claim 1 further comprising the steps of:
forming third and fourth slots in the platform;
providing a second sheet of material having at least a first tab on one side of the sheet of material and at least a second tab on the other side of the sheet of material;
forming the second sheet of material into a brace member;
inserting the first tab of the second sheet of material into the third slot; and,
inserting the second tab of the second sheet of material into the fourth slot.

16. A liftgate assembly comprising:
a mount assembly for use in mounting a liftgate assembly to an associated vehicle;
a platform assembly comprising:
(a) a platform support structure comprising a plurality of non-tube brace members, wherein each non-tube brace member comprises at least a first and a second tab; and,
(b) a platform comprising a traffic surface for use in receiving traffic for loading and unloading cargo and a plurality of slots, wherein the tabs of the non-tube brace members are received within the slots in order to attach the platform to the platform support structure; and,
a lift assembly for use in moving the platform assembly between a lowered position and a raised position.

17. The liftgate assembly of claim 16 wherein the plurality of slots penetrate the platform to create holes through the platform.

18. The liftgate assembly of claim 16 wherein the plurality of non-tube brace members are each substantially U-shaped.

19. The liftgate assembly of claim 16 wherein the plurality of non-tube brace members are each substantially V-shaped.

20. The liftgate assembly of claim 16 wherein the plurality of non-tube brace members each have a bottom and a pair of sides, wherein at least one of the sides is angled at a substantially non-perpendicular angle with respect to the bottom.
